(19) United States
(12) Patent Application Publication
(10) Pub. No.: US 2011/0060812 A1
(43) Pub. Date: Mar. 10, 2011

(54) CACHE SERVER WITH EXTENSIBLE PROGRAMMING FRAMEWORK

(75) Inventor: Ted Middleton, Moorpark, CA (US)

(73) Assignee: Level 3 Communications, LLC

(21) Appl. No.: 12/836,418

(22) Filed: Jul. 14, 2010

Related U.S. Application Data
(60) Provisional application No. 61/241,306, filed on Sep. 10, 2009.

(51) Int. Cl. G06F 15/16

(52) U.S. Cl. 709/219

(57) ABSTRACT

Embodiments generally disclosed herein include methods, systems and devices for providing an extensible content delivery platform. The methods, systems and devices include identifying a plurality of discrete events of a content delivery process of a content delivery network and providing a structured object model comprising a plurality of objects instantiated and available at the plurality of discrete events. The methods, systems and devices further include providing a programmatic grammar configured to provide a logical flow of actions being applied against the plurality of objects on occurrence of at least one of the plurality of discrete events of the content delivery process of the content delivery network.

### CROSS-REFERENCE TO RELATED APPLICATIONS

This application claims the benefit of priority to U.S. Provisional Patent Application 61/241,306, filed Sep. 11, 2009, titled “Cache Server with Extensible Programming Framework,” which is incorporated herein by reference for all purposes.

### TECHNICAL FIELD

Embodiments presently disclosed relate to an extensible content delivery platform for a content delivery network.

### BACKGROUND

Internet use has grown tremendously in recent years. The types and sources of content on the Internet have also grown. For example, computer users often access the Internet to download video, audio, multimedia, or other types of content for business, entertainment, education, or other purposes. Today, users can view live presentations of events, such as sporting events, as well as stored content, such as videos and pictures. The providers of such content typically want to have some level of control over the manner in which the content is viewed and by whom. For example, the provider of videos may want certain videos (e.g., selected videos, or type or class of videos) to be encrypted upon distribution. Users typically want content “on-demand”, and would prefer not to wait a long time for download before viewing the content. Certain types of content tend to take longer than others to download. For example, download of a movie can take many minutes or hours, depending on the type of download technology used and the size of the movie file.

Typically providers of Internet content are separate entities from the network providers that provide the infrastructure to distribute the content. To reach a very large audience, content providers typically purchase the services of a content delivery network provider, which generally has a large network infrastructure for distributing the content. However, because content providers typically do not have control over distribution, the providers typically have limited control over how, or to whom, the content is distributed.

A cache server is a dedicated network server or service acting as a server in a content delivery network that temporarily stores content for access by users. Cache servers both speed up access to data and reduce demand on an enterprise's bandwidth. Cache servers also allow users to access content when a content server is offline or otherwise unavailable, including rich media files or other documents.

Cache servers can be feature rich. Features are complex, sometimes interdependent, and often inconsistent in style and configuration. Features of traditional cache servers have been historically challenging to describe, document, and train users. New features require significant code changes resulting in extended lead times, code complexity, testing and bug fix cycles, and the like. New features are also typically implemented in a reasonably flexible way—anticipating multiple possible use cases, configuration scenarios, and the like—that further increases the complexity of the solution.

### SUMMARY

An extensible content delivery platform is provided upon which applications and services can be built around underlying content to be served. Rich and well-formed metadata and “metacode” can be associated with content and/or requests in a consistent and programmatic manner. In an exemplary embodiment, the applications and services (e.g., modules and/or scripts) are executed based upon an event that occurs (e.g., an event that occurs in processing a request for content). The event can be identified in a number of different ways. In one implementation, for example, a set of rules is used to identify one or more events for which applications and/or services are identified and executed. In another exemplary implementation, a system provides a structured “event” model, primitive functions, and language constructs to create a service layer that can be leveraged in flexible ways without requiring core code changes.

In one particular implementation of such a system, a “wrapper” is constructed around existing rule-based and other configuration tables without a wholesale replacement of existing techniques. In this implementation, the “wrapper” allows the system to be presented as a consistent, single interface to access underlying capabilities of an existing cache server in a logically represented way.

The extensible content delivery platform provides for reduced code complexity and enhanced maintainability. A core code provides a set of underlying operating services that supports existing and future features that can be built using the core underlying operating services rather than requiring core code changes. In one such implementation, for example, the core underlying operating services include object caching, instruction interpretation, instruction execution, and the like.

In an embodiment, the extensible content delivery platform also provides for flexible implementation (e.g., enriched extensibility, customization, and application integration potential) without core code changes. Using such an extensible content delivery platform, developers could create virtually unlimited potential applications on the platform.

In one implementation, an extensible content delivery platform comprises: (1) a structured event model, a (2) structured object model, (3) a set of base functions or actions, and (4) a basic programmatic grammar. In this implementation, the structured event model comprises a consistently described documented process for receiving, processing, and servicing requests for content. A discrete number of “events” in a processing pipeline provide “action points” in the content delivery process at which various actions can be taken (e.g., by custom logic). The event model thus provides a more fluid event driven paradigm instead of a rigid rule based system.

The structured object model instantiates a series of objects. In an embodiment, for example, requests, resources, responses, and other “objects” are defined to obtain and/or manipulate various consistent properties and/or attributes.

The base functions or actions provide for functions or actions to be performed at discrete events and upon various objects. In an embodiment, for example, functions or actions comprise operations such as string parsing and/or manipulation, hypertext transfer protocol (HTTP) message construction and/or decomposition, resource manipulation, and the like.

In an embodiment, the basic programmatic grammar is used to create a logical flow of actions being applied against objects on an occurrence of an event. The programmatic grammar, for example, may be as rich as one of the more common web-development languages (PHP, Python, Javascript, Perl, or the like) or a specialty sub-set that provides a restricted set of “safe” or other restricted functions.

Other implementations are also described and recited herein.

### BRIEF DESCRIPTIONS OF THE DRAWINGS

FIG. 1 illustrates an example network environment suitable for distributing content within an extensible content delivery platform according to various embodiments.

FIG. 2 illustrates a system in terms of functional modules for distributing content within an extensible content delivery platform according to various embodiments.

FIG. 3 is a functional module diagram illustrating one possible implementation of a streaming cache module according to various embodiments.

FIG. 4 is a state diagram illustrating one possible set of states that a streaming cache module can enter according to various embodiments.

FIGS. 5-7 are flowcharts illustrating example processes for streaming content.

FIG. 8 illustrates another example network environment suitable for distributing content within an extensible content delivery platform according to various embodiments.

FIG. 9 illustrates yet another example network environment suitable for distributing content within an extensible content delivery platform according to various embodiments.

FIG. 10 illustrates an example extensible programming framework implemented within a cache server of a content delivery network.

FIG. 11 illustrates a block diagram of an example structured content delivery event model.

FIG. 12 is an example block diagram of a computer system configured with a content streaming application and process according to embodiments herein.

### DETAILED DESCRIPTIONS

Embodiments presently disclosed relate to an extensible content delivery platform for a content delivery network.

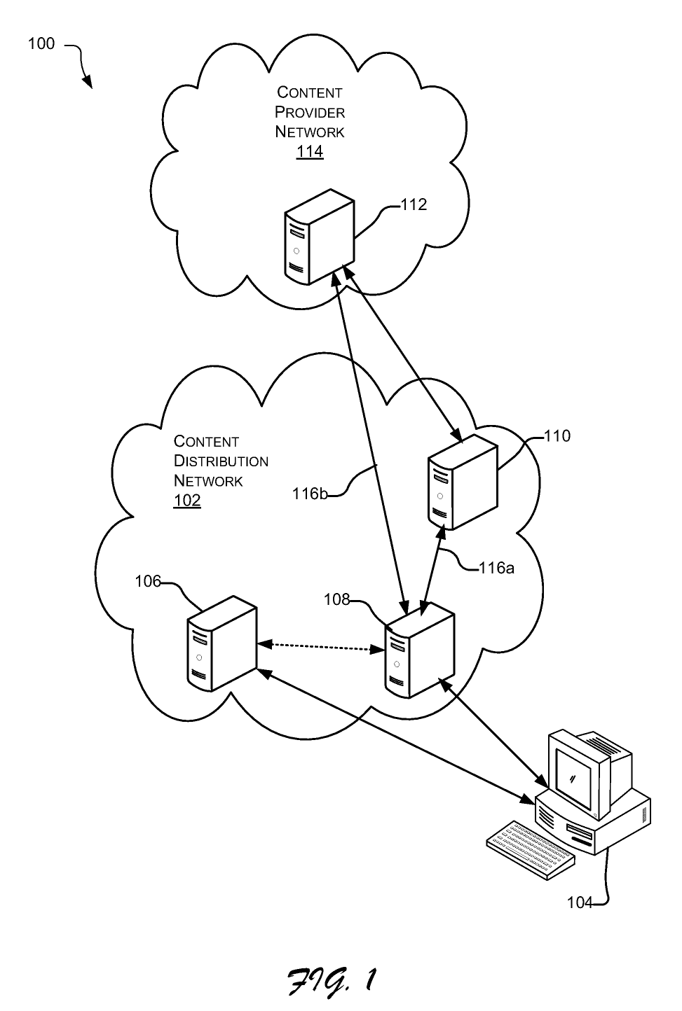

FIG. 1 illustrates an example network environment 100 suitable for distributing content supporting an extensible content delivery platform according to various embodiments. A computer user may access a content distribution network (CDN) 102 using a computing device, such as a desktop computer 104. The CDN 102 is illustrated as a single network for ease of illustration, but in actual operation as described in more detail below, CDN 102 may typically include one or more networks.

For example, network 102 may represent one or more of a service provider network, a wholesale provider network and an intermediate network. The user computer 102 is illustrated as a desktop computer, but the user may use any of numerous different types of computing devices to access the network 102, including, but not limited to, a laptop computer, a handheld computer, a personal digital assistant (PDA), or a cell phone.

The network 102 may be capable of providing content to the computer 104 and supporting an extensible content delivery platform for the network environment 100. Content may be any of numerous types of content, including video, audio, images, text, multimedia, or any other type of media. The computer 104 includes an application to receive, process and present content that is downloaded to the computer 104. For example, the computer 104 may include an Internet browser application, such as Internet Explorer™ or Firefox™, and a streaming media player, such as Flash Media Player™ or Quicktime™. When the user of computer 104 selects a link (e.g., a hyperlink) to a particular content item, the user's web browser application causes a request to be sent to a directory server 106, requesting that the directory server provide a network address (e.g., and Internet protocol (IP) address) where the content associated with the link can be obtained.

In some embodiments, directory server 106 is a domain name system (DNS), which resolves an alphanumeric domain name to an IP address. Directory server 106 resolves the link name (e.g., a universal resource locator (URL)) to an associated network address and then notifies the computer 104 of the network address from which the computer 104 can retrieve the selected content item. When the computer 104 receives the network address, the computer 104 then sends a request for the selected content item to a computer, such as streaming server computer 108, associated with the network address supplied by the directory server 106.

In the particular embodiment illustrated, streaming server computer 108 is an edge server (or cache server) of the CDN 102. Edge server computer 108 may be more or less strategically placed within the network 102 to achieve one or more performance objectives such as reducing load on interconnecting networks, freeing up capacity, scalability and lowering delivery costs. The edge server 108, for example, may cache content that originates from another server, so that the cached content is available in a more geographically or logically proximate location to the end user. Such strategic placement of the edge server 108 could reduce content download time to the user computer 104.

Edge server computer 108 is configured to provide requested content to a requester. As used herein, the term “requester” can include any type of entity that could potentially request content, whether the requester is the end user computer or some intermediate device. As such, a requester could be the user computer 104, but could also be another computer, or a router, gateway or switch (not shown) requesting the content from the edge server computer 108. As will be understood, requests generated by the computer 104 are typically routed over numerous “hops” between routers or other devices to the edge server computer 108. Accordingly, a requester of content could be any of numerous devices communicably coupled to the edge server computer 108.

As part of the function of providing requested content, the edge server computer 108 is configured to determine whether the requested content is available locally from the edge server computer 108 to be provided to the requester. In one embodiment, the requested content is available if the content is stored locally in cache and is not stale. In one particular implementation, stale is a condition in which the content is older than a prescribed amount of time, typically designated by a “time-to-live” value, although other measures may also be used. The edge computer server 108 is configured with media streaming server software, such as Flash Media Server™ (FMS) or Windows Media Server™ (WMS). As such, if the requested content is found to be locally stored on the edge computer server 108 and the cached content is not stale, the media streaming software can stream the requested content to the requester, in this case, the computer 104.

If the edge server computer 108 determines that requested content is not available (e.g., is either not locally stored or is stale), the edge server computer 108 takes a remedial action to accommodate the request. If the content is locally stored but is stale, the remedial action involves attempting to revalidate the content. If the content is not locally stored or revalidation fails (in the case of stale content), the edge server computer 108 attempts to retrieve the requested content from another source, such as a media access server. A media access server (MAS) is a server computer that may be able to provide the requested content.

The edge server 108 comprises an extensible content delivery platform, such as an event-based application programming interface (API) that provides an extensible content delivery platform. The extensible content delivery platform provides for applications and services to be built around underlying content to be served. Rich and well-formed metadata and “metacode” can be associated with content and/or requests in a consistent and programmatic manner. In one implementation, for example, a system provides a structured “event” model, a structured object model, primitive functions, and language constructs to create a service layer that can be leveraged in flexible ways without requiring core code changes.

In one particular implementation of such a system, an API “wrapper” is constructed around existing rule base and other configuration tables without a wholesale replacement of existing techniques. The “wrapper” allows the system to be presented as a consistent, single interface to access underlying capabilities of an existing edge/cache server in a logically represented way.

The extensible content delivery platform provides for reduced code complexity and enhanced maintainability. A core code provides a set of underlying operating services to support existing and future features that can be built using the core underlying operating services rather than requiring core code changes. In one such implementation, for example, the core underlying operating services includes object caching, instruction interpretation, instruction execution, and the like.

In one particular implementation, for example, geo-IP services are instantiated within the platform as a primitive function. In this implementation, an incoming IP address can be used as a key into a database of various geographic or other codes related to that IP address. The database or lookup table would serve as a system “primitive” function that would expose a resulting derived code to a higher-level program module for use in other functions like restricting or allowing access to content, serving alternate variants of content, or the like.

In an embodiment, the extensible content delivery platform also provides for flexible implementation (e.g., enriched extensibility, customization, and application integration potential) without core code changes. In this embodiment, developers can use such an extensible content delivery platform to create virtually unlimited potential applications on the platform.

In the illustrated embodiment, two possible media access servers are shown: a content distribution server computer 110 and a content origin server 112. Content origin server 112 is a server computer of a content provider. The content provider may be a customer of a content distribution service provider that operates the network 102. The origin server 112 may reside in a content provider network 114.

In some embodiments, the content origin server 112 is an HTTP server that supports virtual hosting. In this manner, the content server can be configured to host multiple domains for various media and content resources. During an example operation, an HTTP HOST header can be sent to the origin server 112 as part of an HTTP GET request. The HOST header can specify a particular domain hosted by the origin server 112, wherein the particular domain corresponds with a host of the requested content.

The content distribution server 110 is typically a server computer within the content distribution network 102. The content distribution server 110 may reside logically in between the content origin server 112, in the sense that content may be delivered to the content distribution server 110 and then to the edge server computer 108. The content distribution server 110 may also employ content caching.

In some embodiments, the edge server computer 108 locates the media access server by requesting a network address from the directory server 106, or another device operable to determine a network address of a media access server that is capable of providing the content. The edge server computer 108 then sends a request for content to the located media access server. Regardless of which media access server is contacted, the media access server can respond to a request for specified content in several possible ways. The manner of response can depend on the type of request as well as the content associated with the request.

For example, the media access server could provide information to the edge computer server 108 that indicates that the locally cached version of the content on the edge computer server 108 is not stale. Alternatively, the media access server could send the specified content to the edge computer server 108, if the media access server has a non-stale copy of the specified content. In one embodiment, the media access server includes data transport server software, such as a Hypertext Transport Protocol (HTTP) server, or web server. In this case, the edge server computer 108 interacts with the media access server using the data transport protocol employed by the media access server.

With further regard to the communications between the edge server computer 108 and the media access server computer (e.g., either the content origin server 112 or the content distribution server 110), the two servers may communicate over a channel. These channels are illustrated as channel 116a between the edge server computer 108 and the content distribution server 110 and channel 116b between the edge server computer 108 and the content origin server 112. According to various embodiments described herein, channels 116 are data transport, meaning the channels 116 carry data using a data transport protocol, such as HTTP.

The edge server 108 is configured to retrieve content using a data transport protocol while simultaneously streaming content to the content requester. For example, the edge server computer 108 is operable to simultaneously stream requested content to the requester (e.g., the computer 104) while receiving the content from the origin server computer 112 over the data transport protocol channel 116b. Operations carried out by the edge server computer 108 and modules employed by the edge server computer 108 can perform simultaneous streaming and content retrieval.

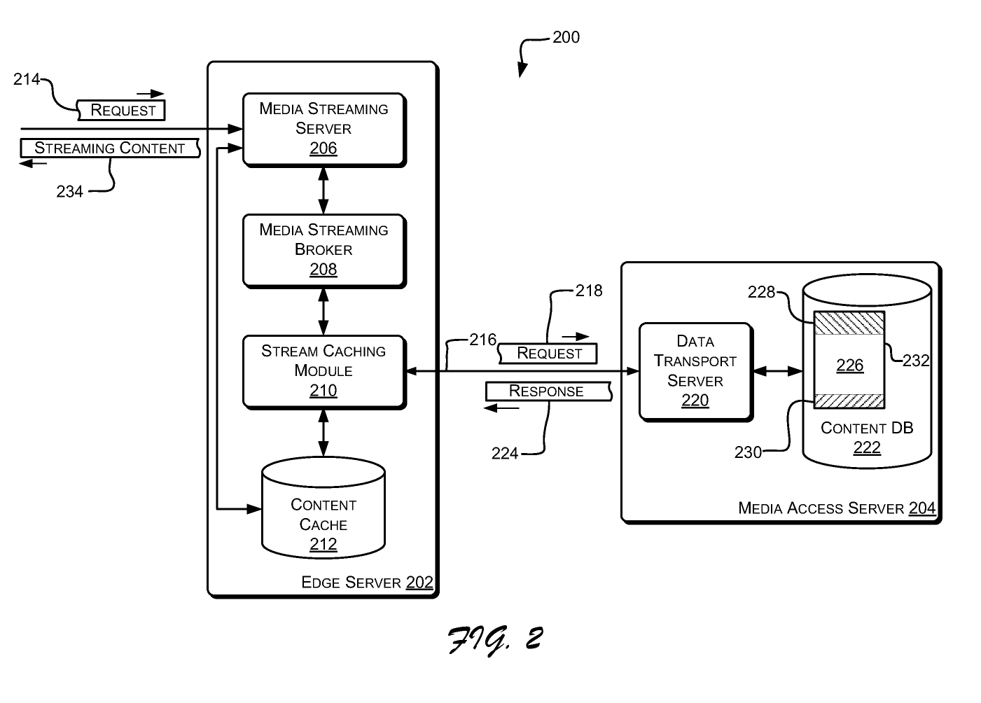

FIG. 2 illustrates a streaming content delivery framework 200 adapted to supporting an extensible content delivery platform including an edge server computer 202 and a media access server computer 204. Edge server computer 202 is configured with modules operable to retrieve content from the MAS 204, if necessary, while streaming the content to an entity that has requested the content. In some embodiments, retrieval of requested content from the MAS 204 is simultaneous with streaming of the content to the requester.

In the embodiment illustrated in FIG. 2, the edge server computer 202 includes a media streaming server 206, a media streaming broker 208, a stream caching module 210 and a content cache 212. In an illustrative scenario, a content request 214 is received from a requester. The content request has various information, including, but not limited to, an identifier of the content being requested. The request 214 may identify a particular portion of the content being requested.

The request 214 is initially received by the media streaming server. The media streaming server 206 could be a Flash Media Server™ (FMS), Windows Media Server™ (WMS), or other streaming media service. The media streaming server 206 is configured to communicate data with a content requester using a data streaming protocol (e.g., Real Time Messaging Protocol (RTMP)) in response to content requests. Upon receipt of request 214, the media streaming server 206 passes the request 214 to the media streaming broker 208 and waits for a response from the broker 208. As such, the media streaming broker 208 maintains the state of the media streaming server 206.

The media streaming broker 208 is operable to serve as a go-between for the media streaming server 206 and the stream caching module 210. As such, the media streaming broker 208 facilitates communications between the media streaming server 206 and the stream caching module 210 to thereby support streaming of content. In one embodiment, the media streaming broker 208 is a software plug-in that uses application programming interfaces (APIs) of the media streaming server 206 to communicate with the media streaming server 206. The media streaming broker 208 is operable to handle requests from the media streaming server 206, maintain some state of the media streaming server 206, and notify the media streaming server when content is in the cache 212. When the media streaming broker 208 receives a content request, the broker 208 generates a content request to the stream caching module 210.

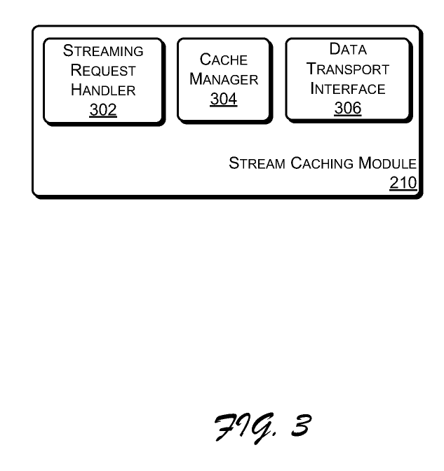

The stream caching module (SCM) 210 includes functionality for responding to content requests from the broker 208. In one embodiment, shown in FIG. 3, which is discussed in conjunction with FIG. 2, the SCM 210 includes a streaming request handler 302, a cache manager 304 and a data transport interface 306. The streaming request handler 302 receives the request from the broker 208 and queries the cache manager 304 whether the requested content is in the cache 212. The cache manager 304 determines if the requested content exists in the cache 212.

If the requested content is in the cache 212, the cache manager 304 of the SCM 210 checks the age of the content to determine if the content is stale. Generally, each content item has an associated time-to-live (TTL) value. The cache manager 304 notifies the request handler 302 of the results of the checks on the requested content; i.e., whether the content exists, and if so, whether the content is stale.

If the content exists in the cache 212 and is not stale, the request handler 302 notifies the media streaming server 206 via the media streaming broker that the content is ready to be streamed and provides a location in the cache 212 from which the content can be read. If the content is not in the cache 212, or the content is stale, the request handler 302 notifies the data transport interface 306. The data transport interface 306 is configured to communicate over a data transport channel, such as an HTTP channel 216, to the MAS 204.

The data transport interface 306 transmits a request 218 to the MAS 204 identifying the requested content. The request 218 may be one of several different types of requests, depending on the situation. For example, if it was determined that the requested content was in the cache 212, but the content was stale, the data transport interface 306 transmits a HEAD request (in the case of HTTP) to the MAS 204 indicating that the current state of the requested content in the local cache is stale. If the requested content is not in the cache 212, the data transport interface 306 transmits a GET (in the case of HTTP) request to the MAS 204 to retrieve at least a portion of the content from the MAS 204. The MAS 204 includes a data transport server 220, which receives and processes the request 218.

The data transport server 220 is configured to communicate via a data transport protocol, such as HTTP, over the data transport channel 216. Initially, the data transport server 220 determines if the content identified in the request 218 is in a content database 222 accessible to the MAS 204. The data transport server 220 queries the content database 222 for the requested content. Based on the response of the content database 222, the data transport server 220 generates a response 224, the contents of which depend on whether the requested content is in the database 222.

The response 224 generally includes a validity indicator, which indicates that the request 218 was or was not successfully received, understood and accepted. If the data transport protocol is HTTP, the response 224 indicator is a numerical code. If the requested content is not in the database 222, the code indicates invalidity, such as an HTTP 404 code, indicating the content was not found in the database 222.

If the requested content, for example file 226, is found in the database 222, the response 224 code will be a valid indicator, such as HTTP 2XX, where “X” can take on different values according to the HTTP definition. If the request 218 to the MAS 204 is a HEAD request, and the content is found in the database 222, the response 224 typically includes an HTTP 200 code. The response 224 to a HEAD request also includes information indicating whether the TTL of the content in cache 212 is revalidated or not. In the case of a GET request, and the requested content, e.g., file 226, is found in the database 222, the response 224 includes an HTTP code, along with a portion of the content 226.

The data transport interface 306 of the stream cache module 210 receives the response 224 and determines the appropriate action to take. In general, the data transport interface 306 notifies the streaming request handler 302 as to whether the content was found by the MAS 204 or not. If the content was not found by the MAS 204, and, assuming the cache manager 304 did not find the content in cache 212, the streaming request handler 302 notifies the media streaming server 206 via the media streaming broker 208 that the requested content is not found.

If the response 224 is a valid response to a HEAD request, the response 224 will indicate whether the TTL of stale content in cache 212 has been revalidated. If the TTL is revalidated, the cache manager 304 updates the TTL of the validated content and notifies the streaming request handler 302 that the content is available in cache 212 and is not stale. If the response 224 indicates that the stale content in cache 212 is not revalidated, the cache manager 304 deletes the stale content and indicates that the content is not in cache 212. The streaming request handler 302 then requests the content from the data transport interface 306.

A GET request can specify a portion of the content to be retrieved and if the GET request is valid, the response 224 will generally include the specified portion of the identified content. The request 218 can be a partial file request, or a range request, which specifies a range of data in the file 226 to be sent by the data transport server 220. The range may be specified by a beginning location and an amount; e.g., a byte count. Range requests are particularly useful for certain types of content and in response to certain requests, or other situations.

For example, if the requested file 226 is a Flash™ file, the first one or more GET requests will specify the portion(s) of the file 226 that are needed for the media streaming server 206 to immediately start streaming the file 226 to the requester. The entire file 226 is not required in order for the media streaming server 206 to start streaming the file 226 to the requester. In some cases, a particular portion of the content includes metadata about the content that enables the media streaming server 206 needs to start the streaming. Metadata may include file size, file format, frame count, frame size, file type or other information.

It has been found that for a Flash™ file, such as file 226, only a head portion 228 of the file 226 and a tail portion 230 of the file 226 are initially needed to start streaming the file 226 because the head 228 and the tail 230 include metadata describing the file 226. The remainder 232 of the file 226 can be obtained later. In one embodiment, the head portion 228 is the first 2 megabytes (MB) and the tail portion 230 is last 1 MB of the file 226, although these particular byte ranges may vary depending on various factors.

In the case of Flash™ file 226, after the head portion 228 and tail portion 230 of file 226 have been received by the data transport interface 306, the data transport interface 306 stores those portions in the cache 212, and the streaming request handler 302 is notified that the initial portions of the requested content are available in cache 212. The request handler 302 then notifies the streaming media server 206 of the location of the initial portions of the content in the cache 212. The streaming media server 206 then begins reading content from the cache 212 and sending streaming content 234 to the requester.

While the media streaming server 206 is streaming content to the requester, the SCM 210 continues to retrieve content of the file 226 from the MAS 204 until the remainder 232 is retrieved. The data transport interface 306 of the SCM 210 sends one or more additional GET requests to the data transport server 220 of the MAS 204, specifying range(s) of content to retrieve. In some embodiments, the data transport interface 306 requests sequential portions of the file 226 in set byte sizes, such as 2 MB or 5 MB at a time until the entire file 226 has been retrieved. The amount requested with each request can be adjusted depending on various parameters, including real time parameters, such as the latency of communications to and from the MAS 204.

During streaming of the requested content, the requester may issue a location-specific request requesting that data be streamed from a particular specified location within the content. The specified location may or may not yet be stored in the content cache 212. Such a location-specific request is received by the streaming media server 206 and passed to the media streaming broker 208. The streaming media broker 208 sends a request to the request handler 302 of the SCM 210. The request handler 302 requests that the cache manager 304 provide data from the specified location. The cache manager 304 attempts to retrieve data at the specified location in the file from the cache 212.

If the specified location is not yet in the cache 212, the cache manager 304 notifies the request handler 302. The request handler 302 then requests that the data transport interface 306 retrieve content at the specified location. In response, the data transport interface 306 sends a GET request specifying a range of data starting at the specified location, regardless of whether and where the data transport interface 306 was in the midst of downloading the file 226.

For example, if the location specified by the requester is at the end of the file 226, and the data transport interface 306 is in the process of sequentially downloading the file 226 and is at the beginning of the file 226, the data transport interface 306 interrupts its sequential download and sends a range request for data starting at the specified location. After content is retrieved from the specified location the data transport interface 306 resumes its sequential download from where it left off prior to receiving the location-specific request.

The components of the edge server 202, the MAS 204 and the stream cache module of FIG. 3 may be combined or reorganized in any fashion, depending on the particular implementation. For example, the data stores (e.g., content cache 212 and content data base 222) may be separate from their associated servers. The data stores may be any type of memory or storage and may employ any type of content storage method. The data stores, such as content cache 212 and database 222, may include database server software, which enables interaction with the data stores.

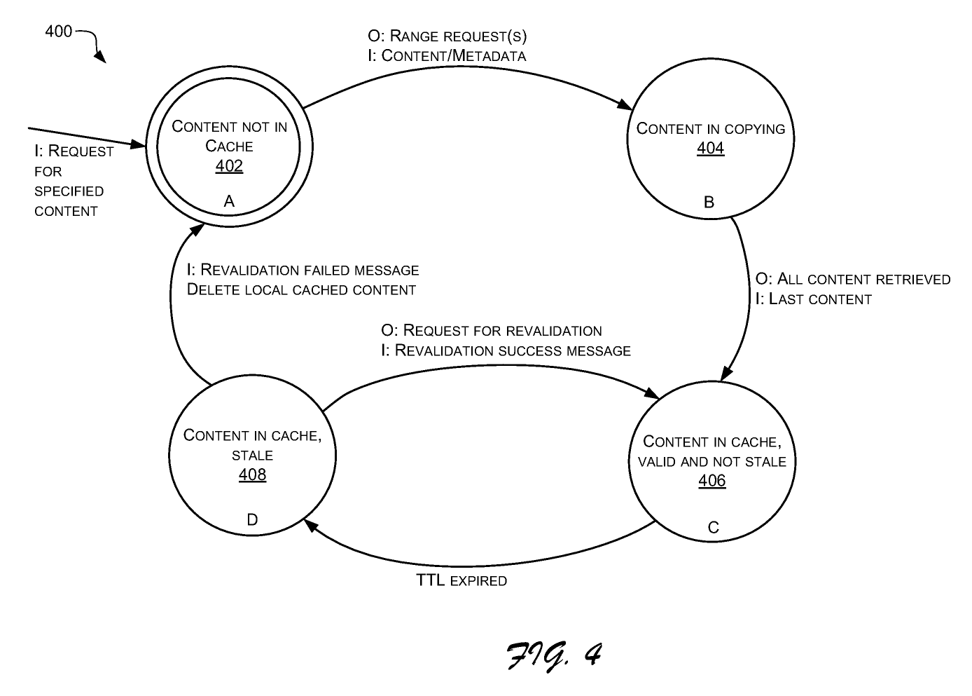

FIG. 4 is a state diagram 400 illustrating states that a streaming cache module, such as stream caching module 210 (FIG. 2), or similar component, may enter, and conditions that cause entry into and exit from those states. Initially, in this example scenario, the SCM 210 may enter state A 402 when the SCM 210 receives a request for specified content. It will be understood that the SCM 210 may enter another state initially, but for purposes of illustration, it is assumed here that the content specified in the request is not in local cache. In state A 402, the SCM determines that the specified content is not in the local cache. Upon determining that the specified content is not in the local cache, the SCM enters state B 404.

Upon entry into state B 404, the SCM outputs one or more range requests to a media access server and begins receiving content and/or metadata from the media access server (MAS). It is assumed in this case that the MAS has, or can obtain, a non-stale copy of the requested file.

With regard to range requests generated by the SCM 210, each of the one or more range requests specifies a beginning location of data and a range of data to be retrieved. The range request is a type of request supported by a data transport protocol, such as HTTP, and is recognized by the MAS, which includes a data transport server, such as an HTTP or web server. Thus, the MAS is able to read the range request(s) and respond with portions of the requested content identified in the range request(s).

An initial range request may specify a location in the file that includes metadata about the file that enables the streaming media server to promptly begin streaming the requested content. Such metadata can include control data or definitions that are used by the streaming media server to stream the content.

For example, in the case of a Flash™ file, the initial range request may specify the head of the Flash™ file, which gives information about the layout of the file, such as entire file size, frame size, total number of frames, and so on. In the case of Flash™ files, the initial range request, or one of the first range requests typically also specifies an end portion of the file because the end portion includes information used by the streaming media server to begin streaming the content of the file. For example, in some embodiments, the SCM generates a range request for the first two megabytes of a specified Flash™ file and the last one MB of the Flash™ file.

In state B 404, the SCM continues to request and receive content data until the entire file is retrieved. The content may be retrieved in sequential order from beginning to end of the content file, or the content may be retrieved in some other order. Out of sequential order retrieval may occur in response to a location-specific request from a user viewing the content to move to another specified location in the file. For example, the user may advance (or “rewind”) to a particular place in the streaming content file through the user's streaming media player.

When the user moves to a particular location in the streaming file, a request is sent to the SCM specifying the particular location in the file to move to. In response, in state B 404, the SCM generates a range request specifying the requested place in the file. The SCM may also notify the streaming media server (e.g., via the media streaming broker 208) when a portion or portions of the content have been stored in local cache, so that the streaming media server can begin streaming those portion(s).

After the requested content file is completely downloaded, the SCM may generate an output indicating the file is downloaded. The SCM then enters state C 406. In state C 406, the SCM waits until the content becomes stale. In state C 406, the SCM checks the age of the content file and compares the age to a specified “time-to-live” (TTL) value, which may be provided in a message from the MAS. When the content file becomes stale, the SCM enters state D 408.

In state D 408, the SCM sends a request to the MAS to revalidate the content file. The MAS may send a message indicating successful revalidation and a new TTL value. If so, the SCM returns to state C 406, where the SCM again waits until the TTL expires. On the other hand, while in state D 408, if the MAS does not revalidate the content, or generates a message indicating a revalidation failure, the SCM returns to state A 402. Before entering state A from state D, the SCM deletes the stale content.

With further regard to the revalidation of content, one embodiment involves the use of HTTP headers. In this embodiment the SCM sends a HEAD request and will expect one of the HTTP headers: Cache-Control or Expires. Those headers provide TTL information. After a given content file is fully downloaded, the SCM checks the TTL of the given content file in response to each incoming request for the file. If the content file ages past the TTL, then the SCM will send another HEAD request to revalidate the content. The response will depend on the media access server. For example, the Apache HTTP Server responds with a “200” response. Upon receipt of the “200” response SCM checks both the modifying time and the file size to make sure the cache content is still valid. As another example, the Microsoft's IIS™ HTTP server responds to a HEAD request with a “200” if the content is modified and stale, or “304” (not modified) if the content is still valid.

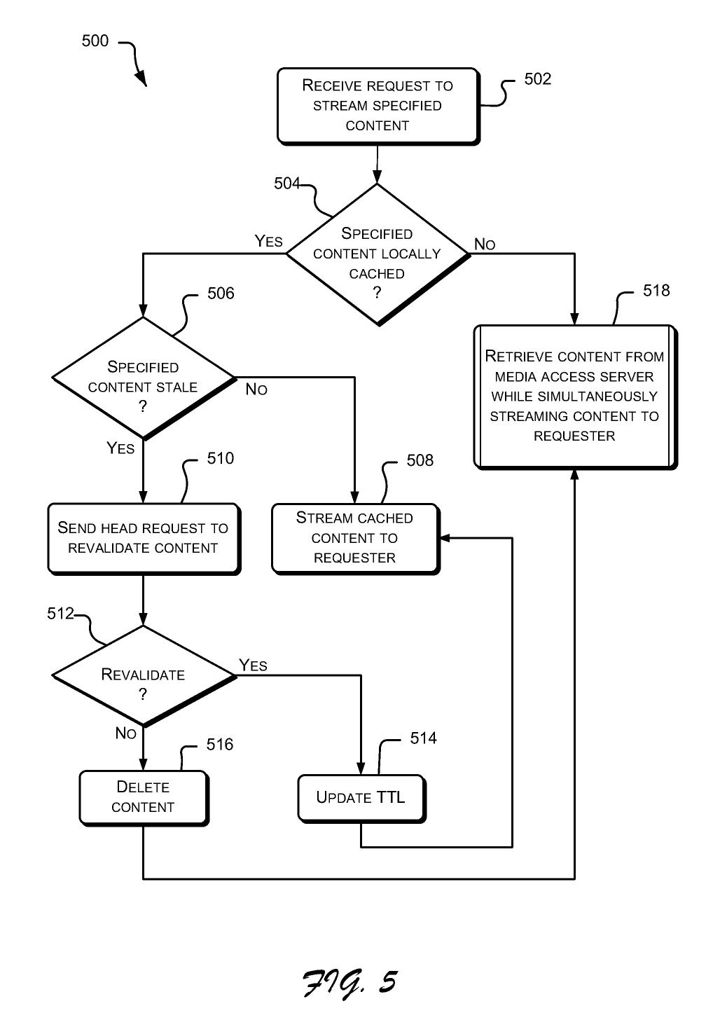

FIGS. 5-7 are flow charts illustrating processes for handling a request to deliver content. As described below, the extensible content delivery platform is supported in the processes. In general, the processes include determining whether content in a local cache is available to be streamed and, if so, streaming the requested content to the requester from the local cache; if not, content is revalidated and/or retrieved from a media access server and simultaneously streamed to the requester. The operations need not be performed in the particular order shown. The operations can be performed by functional modules such as one or more of the media streaming server 206, streaming media broker 208 and stream caching module 210 (FIG. 2), or other modules.

Referring specifically now to FIG. 5, in content request handling operation 500, a request is initially received for specified content in receiving operation 502. The requested content is identified in the request. A query operation 504 determines if the requested content exists in local cache. If it is determined that the requested content exists in local cache, another query operation 506 determines if the content in local cache is stale. In one embodiment, query operation 506 compares the age of the locally cached content to a TTL value associated with the content, and if the age is greater than the TTL value, the content is stale; otherwise the content is not stale.

If the locally cached content is determined to be not stale, the operation 506 branches “NO” to streaming operation 508. In streamlining operation 508, the locally cached content is streamed to the requester. On the other hand, if the locally cached content is determined to be stale, the operation 506 branches “YES” to sending operation 510.

In sending operation 510, a HEAD request is sent to a media access server (MAS) to revalidate the locally cached content. In another query operation 512 checks the response from the MAS to determine whether the locally cached content is revalidated. If the content is revalidated, the operation 512 branches “YES” to updating operation 514. Updating operation 514 updates the TTL value associated with the locally cached content, so that the locally cached content is no longer stale. The locally cached content is then streamed in streaming operation 508.

Returning to query operation 512, if the response from the MAS indicates that the locally cached content is not revalidated, the operation 512 branches “NO” to deleting operation 516. Deleting operation 516 deletes the locally cached content. After deleting operation 516, and if, in query operation 504 it is determined that the requested content is not in the local cache, the operation 504 branches to retrieving operation 518. In retrieving operation 518, the requested content is retrieved from the MAS while the content is simultaneously streamed to the requester.

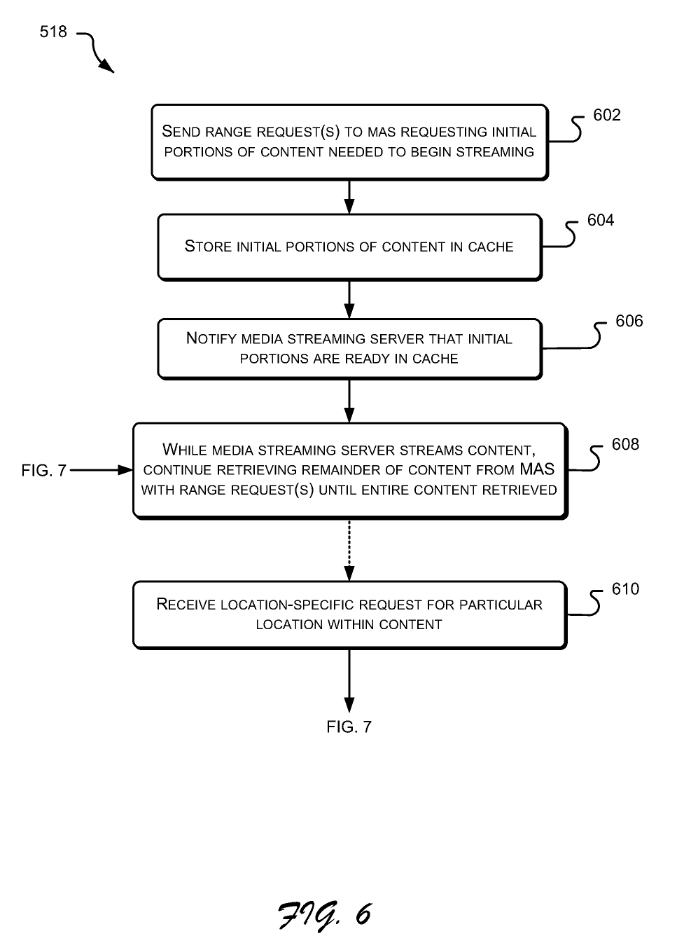

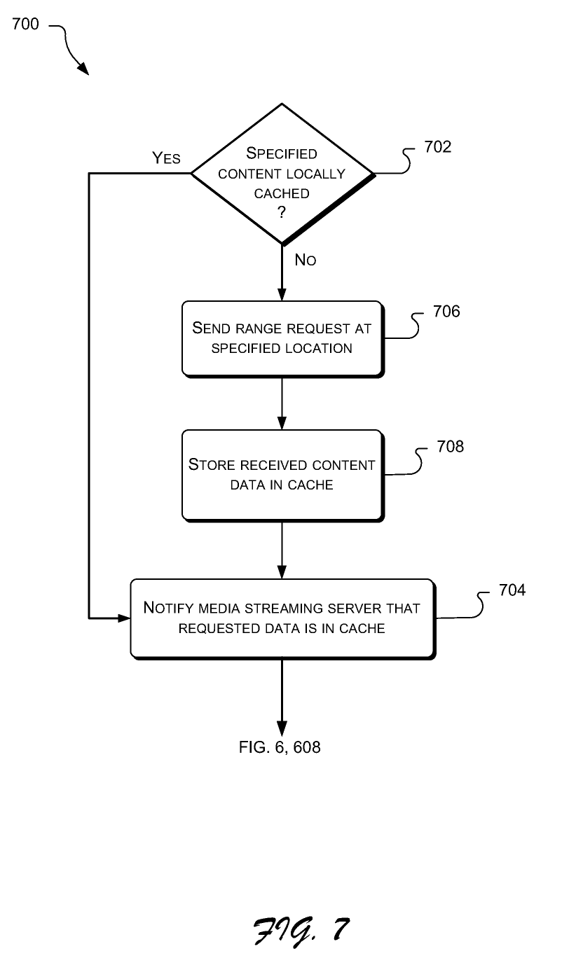

In one embodiment retrieving operation 518 retrieves the content using a data transport protocol (e.g., HTTP) while simultaneously delivering the content using a streaming media protocol. Examples of the retrieving operation 518 are shown in FIGS. 6-7 and described below.

FIG. 6 is a flow chart illustrating a simultaneous retrieval and streaming operation 518. The operations shown in FIGS. 6-7 are typically performed by a stream caching module, such as SCM 210 (FIG. 2), or similar component. The descriptions and scenarios described with respect to FIGS. 6-7 assume that the media access server (MAS) has a non-stale copy of the requested content.

In the case of HTTP, GET requests are sent to the MAS in sending operation 602. The initial one or more GET requests request portion(s) of the content that include metadata describing the layout of the content so that streaming of the content can begin. In one embodiment, for example, when the content to be retrieved in Flash™ media, the first one or two GET requests are range requests for a front portion of the content and an end portion of the content, which contain metadata used to begin streaming.

A storing operation 604 stores the retrieved portions of the content in cache. A notifying operation 606 notifies the streaming media server that the initial portions of the requested content are in cache and ready for streaming. The streaming media server will responsively begin streaming the requested content. Meanwhile, the SCM will continue to retrieve portions of the requested content in retrieving operation 608.

The retrieving operation 608 includes sending one or more additional GET requests for ranges of data in the requested content to the MAS. Content data received from the MAS is stored in cache where the streaming media server can access the content for continued streaming. In one embodiment, retrieving operation 608 retrieves portions of the content sequentially. The portions of content are of a size specified in the range requests. The portion sizes may be set or adapted, depending on various design or real-time parameters. In some embodiments, the portion size is set to 5 MB, but other sizes are possible and likely, depending on the implementation. Retrieving operation 608 continues until the entire content file has been retrieved and stored in cache.

During retrieving operation 608, a location-specific request may be received in receiving operation 610. When a location-specific request is received, the usual order of content retrieval (e.g., sequential) is temporarily interrupted to retrieve content data from the particular location specified in the location-specific request. A particular embodiment of a process of handling a location-specific request is shown in FIG. 7 and described further below.

After handling a location-specific request, the retrieving process 608 resumes. Retrieving operation 608 can continue to retrieve data sequentially after the location specified in the location-specific request, or the retrieving operation 608 could resume retrieval sequentially from where it was when the location-specific request was received.

FIG. 7 is a flow chart illustrating a location-specific requesting handling operation 700, which can be used to respond to a location-specific request when content is being streamed to the requester. As discussed, a location-specific request is a request to provide data at a particular location within content that is currently being streamed. Streaming media protocols are adapted to promptly move to a requested location within a content file.

However, in progressive download protocols, such as progressive download schemes often used with HTTP, moving to a particular place in the content while the content is being downloaded often causes delays because progressive download requires that all data prior to the desired location is downloaded first. Using the scheme shown in FIGS. 6-7 enables streaming of content that would otherwise be delivered via progressive download over a data transport channel, thereby reducing or removing delay associated with a move to a particular location in the content.

Initially, in moving operation 700, a query operation 702 determines whether data at the particular location specified in the location-specific request is stored in local cache. Query operation 702 may utilize a tolerance, whereby it is checked that at least a certain minimum amount of data after the specific location is stored in the local cache. For example, query operation 702 may check that at least 1 MB (or some other amount) of data after the specified location is stored in local cache. By using a tolerance, the moving operation 700 can avoid delays by ensuring that at least a minimum amount of data at the specified location is available for streaming.

If it is determined that at least the minimum amount of data is stored in local cache, the query operation 702 branches “YES” to notifying operation 704. Notifying operation 704 notifies the media streaming server of the location in cache that the requested data is at for delivery. After notifying operation 704, the operation 700 returns to retrieving operation 608 (FIG. 6). As discussed above, retrieving operation 608 may continue retrieving portions of the content after the location specified in the location-specific request, or resume retrieval from the location prior to receiving the location-specific request.

Referring again to query operation 702, if it is determined that the minimum amount of data at the specified location is not stored in cache, the query operation 702 branches “NO” to sending operation 706. Sending operation 706 generates a GET request specifying a range of data after the specified location. The amount of data specified in the range request can be the byte count retrieved in GET requests generated in operation 602 (FIG. 6), or some other byte count. A storing operation 708 receives the requested data and stores the data in the local cache. After storing operation 708, the moving operation 700 branches to notifying operation 704 where the media streaming server is notified of the location of the requested data in cache.

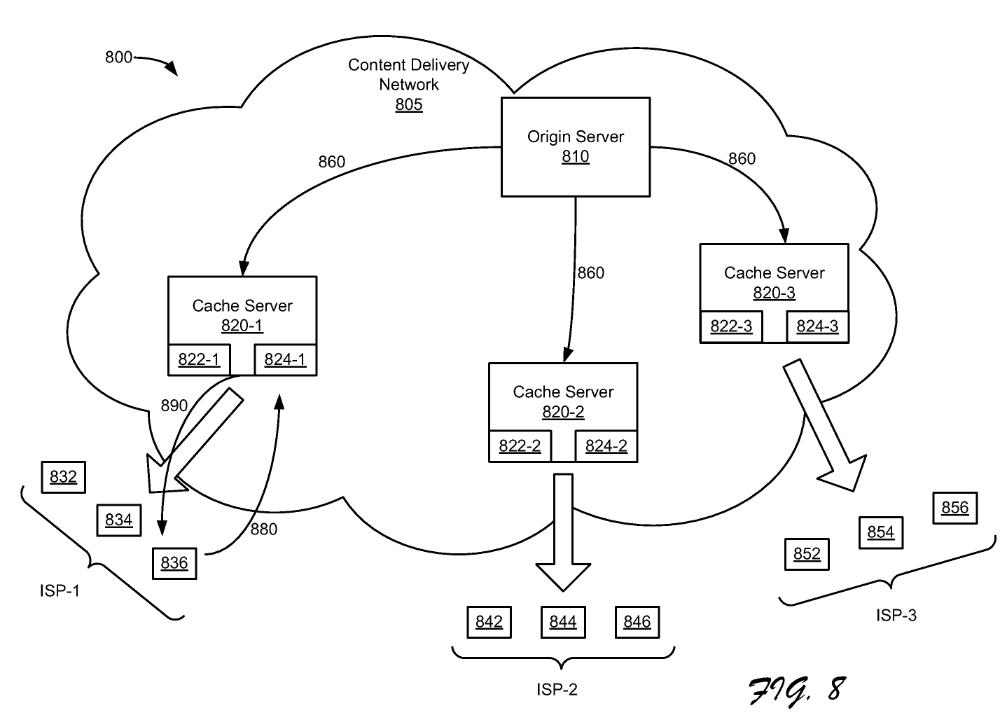

FIG. 8 is a block diagram of another exemplary network environment 800 having a content delivery network 805 that includes an origin server 810, a cache server 820-1, a cache server 820-2 and a cache server 820-3 (hereinafter collectively cache server 820). Each cache server 820 has a respective cache memory 822-1, 822-2, and 822-3, and a respective storage system 824-1, 824-2, and 824-3 (e.g., disk-based or other persistent storage). Cache server 820-1 services requests and provides content to end users 832, 834, and 836 (e.g., client computers) associated with Internet Service Provider 8 (ISP1). Cache server 820-2 services requests and provides content to end users 842, 844, and 846 associated with ISP2. Cache server 820-3 services requests and provides content to end users 852, 854, and 856 associated with ISP3. FIG. 8 shows a cache server dedicated for each ISP for simplicity. Many other implementations are also possible. For example, in various embodiments, one or more ISPs do not have a dedicated cache server, one or more ISPs have a plurality of dedicated cache servers, or the cache servers are not even be correlated to ISPs at all. In one embodiment, for example, one or more cache servers are located remotely (e.g., within an ISP's infrastructure or at an end user's site, such as on a local area network (LAN)) and interact with a remote origin server (e.g., the origin server 810 shown in FIG. 8).

The network environment 800 in FIG. 8 portrays a high-level implementation of content delivery network 805 suitable for implementing and facilitating functionality of the various embodiments described herein. Content delivery network 805 represents just one example implementation of a content delivery network and, as such, it should be noted that the embodiments described herein are similarly applicable for being implemented in any content delivery network configuration commonly practiced in the art. One example content delivery network is described in United States Published Patent Application no. US 2003/0065762 A1 entitled “Configurable adaptive global traffic control and management” filed by Paul E. Stolorz et al. on Sep. 30, 2002, which is incorporated by reference herein in its entirety.

During general operation, the origin server 810 distributes various content (e.g., depending on geography, popularity, etc.) to cache server 820 as shown by lines 860. Assume, for example, that end user 836 requests certain content (e.g., music, video, software, etc.) that is stored on the origin server 810. In this embodiment, the origin server 810 is configured to use the content delivery network 805 to serve content that it contains and optionally has already distributed the requested content to cache server 820-1. The end user 836 is redirected using any number of known methods to instead request the content from cache server 820-1. As shown in the exemplary embodiment of FIG. 8, the cache server 820-1 is configured/located to deliver content to end users in ISP1. The cache server 820-1 can be selected from the group of cache servers 820 using any number of policies (e.g., load balancing, location, network topology, network performance, etc.). End user 836 then requests the content from cache server 820-1 as shown by line 880. Cache server 820-1 then serves the content to end user 836 (line 890) either from cache 822-1 or, if the content is not in the cache, the cache server 820-1 retrieves the content from the origin server 810.

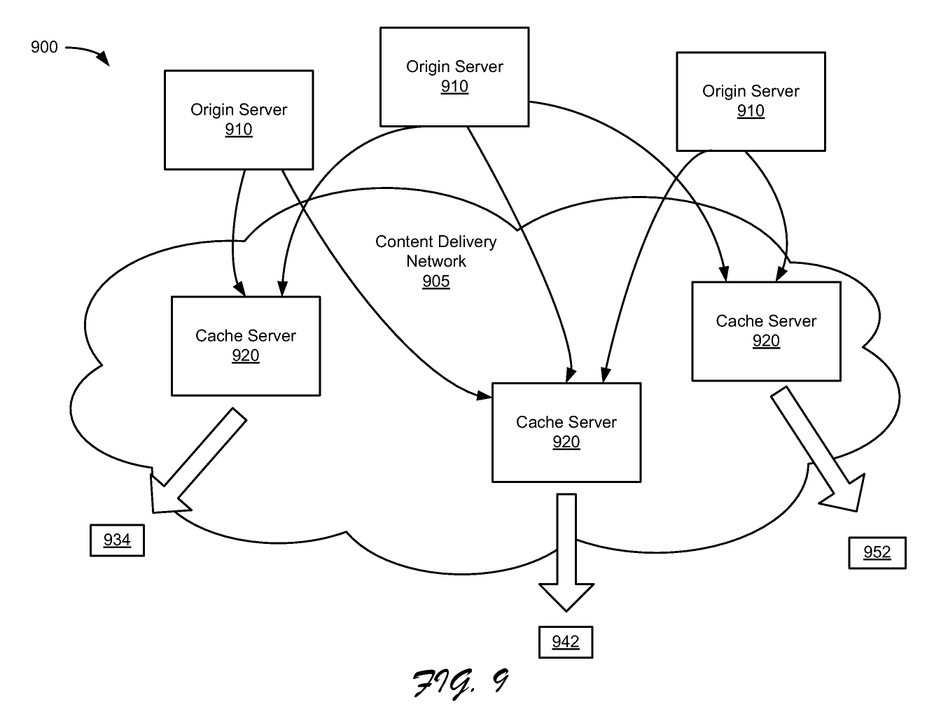

Although FIG. 8 shows the origin server 810 located as part of the content delivery network 805, the origin server 810 can also be located remotely from the content delivery network (e.g, at a content provider's site). FIG. 9 shows such an embodiment, in which a content delivery network 905 interacts with one or more origin servers 910 located at various content provider's sites 908. In this embodiment, the content delivery network 905 includes a plurality of cache servers 920. The cache servers 920 service requests and provide content to end users 932, 942, and 952 (e.g., client computers). The origin servers 910 distribute various content to cache servers 920 as described above with respect to FIG. 8.

The cache server 820 (or 920) comprises an extensible content delivery platform, such as an event-based application programming interface (API) that provides the extensible content delivery platform. The extensible content delivery platform provides for applications and services to be built around underlying content to be served. Rich and well-formed metadata and “metacode” can be associated with content and/or requests in a consistent and programmatic manner. In one implementation, for example, a system provides a structured “event” model, a structured object model, primitive functions, and language constructs to create a service layer that can be leveraged in flexible ways without requiring core code changes.

In one particular implementation of such a system, an API “wrapper” is constructed around existing rule base and other configuration tables without a wholesale replacement of existing techniques. The “wrapper” allows the system to be presented as a consistent, single interface to access underlying capabilities of an existing cache server in a logically represented way.

The extensible content delivery platform provides for reduced code complexity and enhanced maintainability. A core code provides a set of underlying operating services to support existing and future features that can be built using the core underlying operating services rather than requiring core code changes. In one such implementation, for example, the core underlying operating services includes object caching, instruction interpretation, instruction execution, and the like.

In one particular implementation, for example, geo-IP services are instantiated within the platform as a primitive function. In this implementation, an incoming IP address can be used as a key into a database of various geographic or other codes related to that IP address. The database or lookup table would serve as a system “primitive” function that would expose a resulting derived code to a higher-level program module for use in other functions like restricting or allowing access to content, serving alternate variants of content, or the like.

In an embodiment, the extensible content delivery platform also provides for flexible implementation (e.g., enriched extensibility, customization, and application integration potential) without core code changes. In this embodiment, developers can use such an extensible content delivery platform to create virtually unlimited potential applications on the platform.

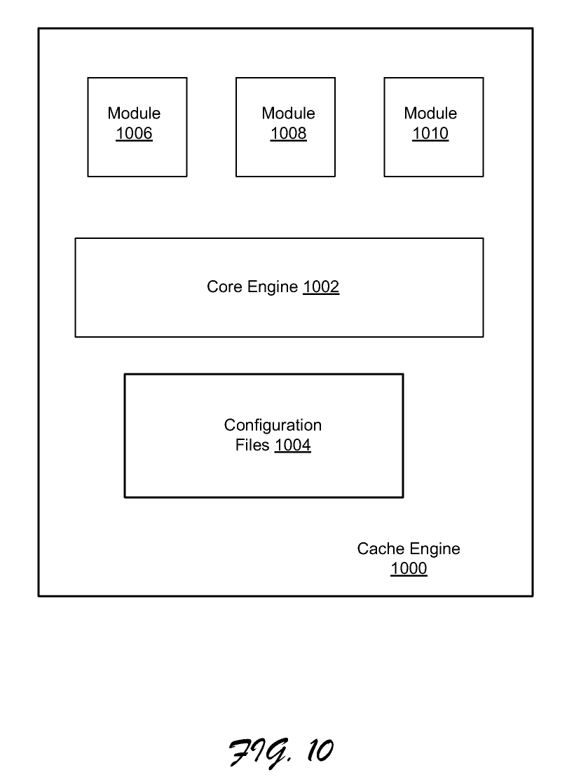

FIG. 10 shows an embodiment of an extensible programming framework 1000 (e.g., an event-based extensible programming framework) to be incorporated within a cache server (e.g., the cache server 120-1 shown in FIG. 8). The framework 1000 comprises a core engine 1002, configuration files 1004, and modules 1006, 1008, and 1010. The core engine 1002 is provided with a core code that provides a set of underlying operating services that support existing and future features that can be built using the core underlying operating services rather than requiring core code changes. In an embodiment, the underlying operating services comprise base functions or actions that the core engine 1002 can perform. Rather than creating complexity in the core engine 1002 to provide various features or services, the core engine 1002 of the extensible programming framework 1000 allows scripts or modules to be associated with the various features or services. In FIG. 10, for example, the modules 1006, 1008, and 1010 provide various customizable features or services without requiring added complexity in the core engine 1002.

In an exemplary embodiment, the underlying operating services of the core engine 1002 include a structured event model, a structured object model, primitive functions or actions that are performed at discrete events and upon various objects, and a programmatic grammar that allows for applications and/or services to be built around the core engine 1002. The structured event model provides a discrete number of events in a content delivery network processing pipeline at which various actions can be taken. The structured object model instantiates a series of objects (e.g., requests, resources, responses, and other objects) that are defined such that various consistent properties and attributes could be obtained and/or manipulated. The set of primitive functions or actions can be performed at discrete events and upon various objects. Examples of such actions comprise operations, such as string parsing and manipulation, HTTP message construction, and decomposition, resource manipulation, and the like.

The modules 1006, 1008, and 1010 provide scripts, instructions, or other code using the defined programmatic grammar. In an embodiment, for example, the modules 1006, 1008, 1010, include specific instantiations developed to exercise functions implemented in the core engine 1002. The modules 1006, 1008, 1010 can be controlled by owners or operators of a content delivery network or can be documented so that many different people can configure a system. Customers, resellers, content partners, or other individuals can be allowed to customize features or services of the content delivery network by providing modules or scripts to be used with the extensible programming framework 1000.

In an example implementation, features are provided that operate on one or more of the following: (1) a property-wide basis (e.g., all requests/content can be affected the same way); (2) resources or groups of resources (e.g., operations can be based on whether a resource being requested matches a set of conditions); (3) request metadata (e.g., a request contains information that can be used to determine one or more operations to be performed); (4) response metadata (e.g., information conveyed from an origin or intermediate content delivery network node during the course of obtaining a requested resource); and (5) combinations of the above conditions with metadata instantiated within the cache server or from external applications/services.

The core engine 1002 interprets scripts, instructions, or other code within the modules 1006, 1008, and 1010 and executes the scripts, instructions, or other code to provide customized features or services within the content delivery network. The modules 1006, 1008, and 1010 alleviate the need for detailed configuration files within the core engine to provide similar features and services directly from the core engine. The modules 1006, 1008, and 1010 provide an extensible platform to write custom logic for features and services within a content delivery network. In one particular embodiment, scripts within modules 1006, 1008, and 1010 are associated with particular content available via a content delivery network. The scripts are then executed every time a user attempts to access that particular content.

In an embodiment, the modules 1006, 1008, and 1010 provide for authentication services for different customers. In one example, the modules 1006, 1008, and 1010 provide instructions that result in blocking and/or allowing access to particular sets of content (e.g., by geographic region, permission, or the like). The first module 1006, for example, provides instructions that result in blocking access to users in one particular set of regions, while the second module 1008 provides instructions that result in blocking access to users in a different set of regions for a different set of content. These modules are invoked for different users and/or requests at different times depending upon a specific combination of configuration files 1004; rules, metadata, or other information resident in the core module 1002; and/or metadata in a request for content (see, e.g., request 180 shown in FIG. 1). In such an example, the first module 1006 is executed for all users requesting content of a certain profile (e.g., directory, name, file-type, or the like). The second module 1008, however, is applied to requests for a different set of content (and/or for content having a different property or profile). The modules 1006, 1008, and 1010, for example, are created and/or stored within a content delivery network (e.g., the content delivery network 105 shown in FIG. 1). The modules are then applied to transactions and/or requests for content based upon specific rules and/or events.

In an embodiment, a set of tables is used to allow for a definition of rules, modules, procedures, plug-ins, or the like. Modules, for example, could be stored as named procedures having optional input arguments and output return values. The modules could also be named for invocation using a rules engine or explicit invocation via request/response headers or other HTTP constructs such as query string elements. In an embodiment, a decoupling of named modules and rule base or script allows for a single module to be authored and stored in a content delivery network once, but invoked using various criteria/rules (e.g., via optional arguments that trigger different behavior).

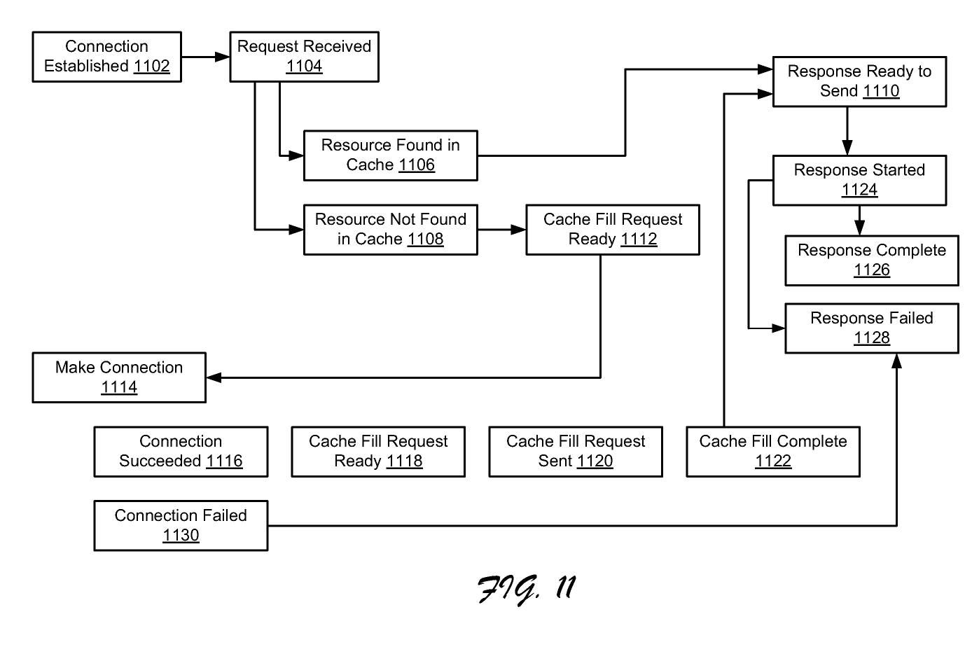

FIG. 11 is a block diagram of one possible implementation of a structured content delivery event model 1100. In the embodiment of FIG. 11, the event model 1100 identifies discrete events within one or more content delivery process at which various actions can be taken through customizable modules or scripts within an extensible content delivery platform. The event model 1100 is, however, merely one example of an event model that can be used to identify discrete events within a content delivery network. Many different ways of identifying certain events at which one or more modules are invoked at various points in a processing pipeline are possible. In another example implementation, for example, a set of rules is used to detect certain discrete events out of multiple possible events at which various actions are to be taken through customizable modules or scripts within the extensible content delivery platform.

In the event model 1100 shown in FIG. 11, a content delivery process is initiated when a connection with a user is established at operation 1102. A request for a content resource is received over the connection in operation 1104. If the content resource is found in the cache of the cache server, a “Cache Hit” is identified in operation 1106. Alternatively, if the content resource is not found in the cache, a “Cache Miss” is identified in operation 1108.

Where a Cache Hit indicates that the requested content resource is found in the cache, the event model next proceeds to operation 1110 at which a response to the request is ready to be sent to the user.

Where a Cache Miss indicates that the requested content resource is not found in the cache, however, the event model proceeds to operation 1112 at which a Cache Fill request is prepared to request the content resource from another source (e.g., the origin server 110 shown in FIG. 1 or the remote content provider origin server 110A shown in FIG. 1A). The event model also establishes a connection to the alternate content source in operation 1114, and determines if the connection succeeds or fails. If the connection to the alternate content source is determined to have succeeded in operation 1116, the event model 1100 proceeds to operation 1118 in which a Cache Fill request is ready and to operation 1120 in which the Cache Fill request is sent to the alternative content source. When the Cache Fill is complete in operation 1122, the event model 1100 proceeds to operation 1110 indicating that a response to the user's request for content is ready to be sent to the user.

Once the response is ready to be sent to the user at operation 1110 (whether from a Cache Hit in operation 1106 or from a Cache Fill in operations 1112 through 1122), the event model 1100 proceeds to operation 1124 in which the response serving the requested content to the user is initiated. If the response serving the requested content to the user completes successfully, the event model 1100 indicates the success in operation 1126. If the response fails, however, the event model indicates the failure in operation 1128.

If the connection to the alternate content source to fill the cache is determined to have failed in operation 1130, however, the event model 1100 proceeds to operation 1128 to indicate the failure to serve the content.

From the event model 1100, discrete events at which customizable modules or scripts can be implemented to provide custom features or services are identified. In one embodiment of a content delivery network servicing HTTP/S requests, for example, events in the process comprise a Receive Request (e.g., an HTTP request received by the content delivery network), a Find Resource (e.g., a determination of whether a resource is present in the cache of a cache server or a consultation of a service to determine whether the resource can be found in the content delivery network), a Cache Hit (e.g., an indication that the resource is found in the cache), a Cache Miss (e.g., an indication that the resource is not found in the cache), a Cache Fill (e.g., an indication that the resource has been retrieved from a source within the content delivery network), an Authenticate Request (e.g., an indication that the request is authenticated), a Construct Response (e.g., a response built by the content delivery network cache server that include associated headers, response bodies, and/or the like), and an Issue Response (e.g., an indication that the response is sent to a requesting user). These events are merely examples of discrete events that can be identified within a process of serving content delivery requests at a cache server of a content delivery network. Other discrete events can also be identified.

In an embodiment, an extensible programming framework of a cache server also provides several types of objects that could be operated on during the processing of requests such as those described above with respect to FIG. 11. Examples of the types of objects include connections (e.g., TCP layer information, client properties, and the like), requests (e.g., request headers and request body), resources (e.g., resource body and resource metadata such as attributes of object and cache control settings), responses, (e.g., response headers and response body), and servers (e.g., attributes relating to the content delivery network server, node, or cluster). These object types are merely examples of types of objects that can be operated on during processing of requests for content. Other object types can also be operated on.

The objects and their attributes can be instantiated and available for appropriate points in an event pipeline. In an embodiment, attributes (e.g., geography codes, server region, and the like) are available via function calls. In an embodiment, for example, the calls are events or part of the programming grammar to be used in developing customized features or services.

Various actions can also be performed during the processing of a request for content. In an embodiment, for example, these actions include manipulating aspects of the transaction, result in additional transactions being spawned, and the like. Examples of actions to be performed include creating a custom header and/or body for a response (e.g., content watermarking, application of security check summing, file chunking/unchunking, streaming of a continuous stream of bytes from a single response, etc.), creating a new request (e.g., on the basis of an authentication request, a request of an alternate or related resource, and the like), deleting a response header that would otherwise be present, setting a new value of a response header, and sending a constructed request to a location (e.g., an arbitrary location), await the response, and act on one or more attributes of the response. Other actions can be viewed as functions or primitives of the programmatic grammar language itself, such as operations common to many programming languages (e.g., string functions and math functions). Still other actions can be specific operations for obtaining metadata known to the content delivery network. In one embodiment, for example, an operation of ClientGeography(“Country”) returns a country code of a requesting client (e.g., by finding an IP address of a client or connection object or by extracting the code from an object and passed as a more generic type of function such as a GetGeography(<level>,<address>) function). Similarly, in an embodiment, a GetServerIP( ) function or a GetHeader(“name”) operation is used to obtain metadata.

In an embodiment, scripts or other customizable code are used to provide features or services with a cache server of a content delivery network. In one implementation, for example, a script is associated with a resource available on the content delivery network and is pre-configured (e.g., stored in a table), attached to a resource (e.g., attached to a response header or body), or otherwise associated with the resource. Many possible mechanisms for associating a script or module with a request are possible. In an implementation, for example, a script (along with its associated functions, arguments, and the like) is stored as a named resource within the system. The named resource is then executed (1) via a registered event within the core engine, (2) via a matching rule set (e.g., execute module “X” if a request for a specific set of content is received), (3) via an explicit association by a content publisher of a request with a module that could be implemented as a query string parameter, a custom header and/or body, or the like, or (4) via an invocation from another script or module.

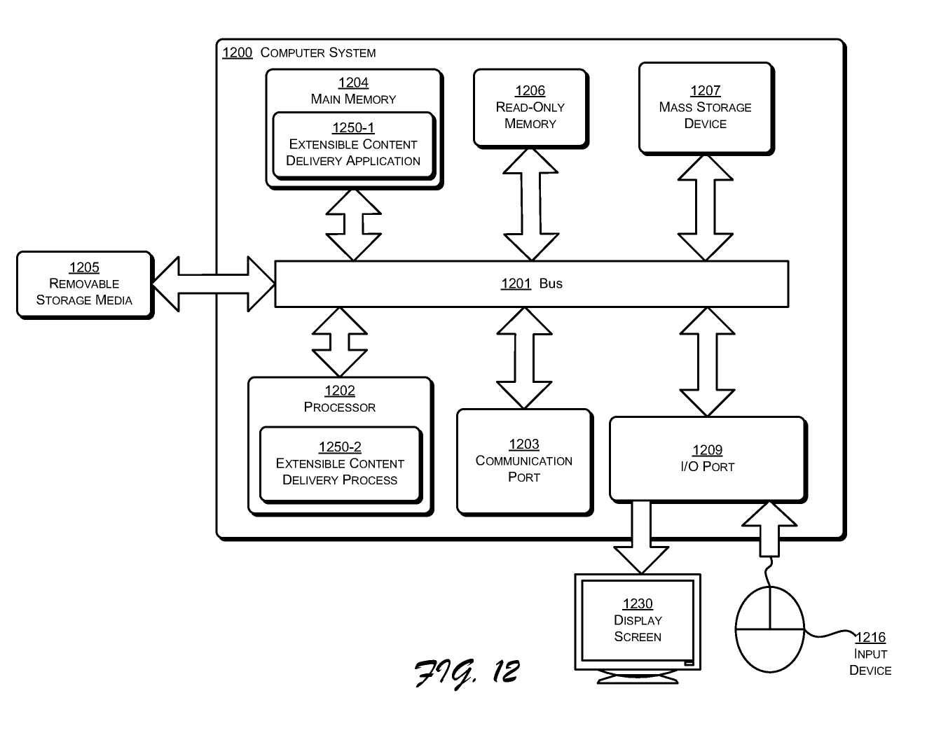

FIG. 12 is a schematic diagram of a computer system 1200 upon which embodiments of the present invention may be implemented and carried out. For example, one or more computing devices 1200 may be used to support an extensible content delivery platform (e.g., for streamed content within a content distribution network). Computer system 1200 generally exemplifies any number of computing devices, including general purpose computers (e.g., desktop, laptop or server computers) or specific purpose computers (e.g., embedded systems).

According to the present example, the computer system 1200 includes a bus 1201 (i.e., interconnect), at least one processor 1202, at least one communications port 1203, a main memory 1204, a removable storage media 1205, a read-only memory 1206, and a mass storage 1207. Processor(s) 1202 can be any known processor, such as, but not limited to, an Intel® Itanium® or Itanium 2® processor(s), AMD® Opteron® or Athlon MP® processor(s), or Motorola® lines of processors. Communications ports 1203 can be any of an RS-232 port for use with a modem based dial-up connection, a 10/100 Ethernet port, a Gigabit port using copper or fiber, or a USB port. Communications port(s) 1203 may be chosen depending on a network such as a Local Area Network (LAN), a Wide Area Network (WAN), or any network to which the computer system 1200 connects. The computer system 1200 may be in communication with peripheral devices (e.g., display screen 1230, input device 1216) via Input/Output (I/O) port 1209.

Main memory 1204 can be Random Access Memory (RAM), or any other dynamic storage device(s) commonly known in the art. Read-only memory 1206 can be any static storage device(s) such as Programmable Read-Only Memory (PROM) chips for storing static information such as instructions for processor 1202. Mass storage 1207 can be used to store information and instructions. For example, hard disks such as the Adaptec® family of Small Computer Serial Interface (SCSI) drives, an optical disc, an array of disks such as Redundant Array of Independent Disks (RAID), such as the Adaptec® family of RAID drives, or any other mass storage devices may be used.

Bus 1201 communicatively couples processor(s) 1202 with the other memory, storage and communications blocks. Bus 1201 can be a PCI/PCI-X, SCSI, or Universal Serial Bus (USB) based system bus (or other) depending on the storage devices used. Removable storage media 1205 can be any kind of external hard-drives, floppy drives, IOMEGA® Zip Drives, Compact Disc-Read Only Memory (CD-ROM), Compact Disc-Re-Writable (CD-RW), Digital Video Disk-Read Only Memory (DVD-ROM), etc.

Embodiments herein may be provided as a computer program product, which may include a machine-readable medium having stored thereon instructions, which may be used to program a computer (or other electronic devices) to perform a process. The machine-readable medium may include, but is not limited to, floppy diskettes, optical discs, CD-ROMs, magneto-optical disks, ROMs, RAMs, erasable programmable read-only memories (EPROMs), electrically erasable programmable read-only memories (EEPROMs), magnetic or optical cards, flash memory, or other type of media/machine-readable medium suitable for storing electronic instructions. Moreover, embodiments herein may also be downloaded as a computer program product, wherein the program may be transferred from a remote computer to a requesting computer by way of data signals embodied in a carrier wave or other propagation medium via a communication link (e.g., modem or network connection).

As shown, main memory 1204 is encoded with extensible content delivery application 1250-1 that supports functionality as discussed herein. Extensible content delivery application 1250-1 (and/or other resources as described herein) can be embodied as software code such as data and/or logic instructions (e.g., code stored in the memory or on another computer readable medium such as a disk) that supports processing functionality according to different embodiments described herein.

During operation of one embodiment, processor(s) 1202 accesses main memory 1204 via the use of bus 1201 in order to launch, run, execute, interpret or otherwise perform the logic instructions of the extensible content delivery application 1250-1. Execution of extensible content delivery application 1250-1 produces processing functionality in extensible content delivery process 1250-2. In other words, the extensible content delivery process 1250-2 represents one or more portions of the extensible content delivery application 1250-1 performing within or upon the processor(s) 1202 in the computer system 1200.

It should be noted that, in addition to the extensible content delivery process 1250-2 that carries out operations as discussed herein, other embodiments herein include the extensible content delivery application 1250-1 itself (i.e., the un-executed or non-performing logic instructions and/or data). The extensible content delivery application 1250-1 may be stored on a computer readable medium (e.g., a repository) such as a floppy disk, hard disk or in an optical medium. According to other embodiments, the extensible content delivery application 1250-1 can also be stored in a memory type system such as in firmware, read only memory (ROM), or, as in this example, as executable code within the main memory 1204 (e.g., within Random Access Memory or RAM). For example, extensible content delivery application 1250-1 may also be stored in removable storage media 1205, read-only memory 1206, and/or mass storage device 1207.

Example functionality supported by computer system 1200 and, more particularly, functionality associated with extensible content delivery application 1250-1 and extensible content delivery process 1250-2 is discussed above with reference to FIGS. 1-11.

In addition to these embodiments, it should also be noted that other embodiments herein include the execution of the extensible content delivery application 1250-1 in processor(s) 1202 as the extensible content delivery process 1250-2. Thus, those skilled in the art will understand that the computer system 1200 can include other processes and/or software and hardware components, such as an operating system that controls allocation and use of hardware resources.

As discussed herein, embodiments of the present invention include various steps or operations. A variety of these steps may be performed by hardware components or may be embodied in machine-executable instructions, which may be used to cause a general-purpose or special-purpose processor programmed with the instructions to perform the operations. Alternatively, the steps may be performed by a combination of hardware, software, and/or firmware. The term “module” refers to a self-contained functional component, which can include hardware, software, firmware or any combination thereof.

The embodiments described herein are implemented as logical steps in one or more computer systems. The logical operations are implemented (1) as a sequence of processor-implemented steps executing in one or more computer systems and (2) as interconnected machine or circuit modules within one or more computer systems. The implementation is a matter of choice, dependent on the performance requirements of the computer system implementing the invention. Accordingly, the logical operations making up the embodiments of the invention described herein are referred to variously as operations, steps, objects, or modules. Furthermore, it should be understood that logical operations may be performed in any order, unless explicitly claimed otherwise or a specific order is inherently necessitated by the claim language.

Various modifications and additions can be made to the example embodiments discussed herein without departing from the scope of the present invention. For example, while the embodiments described above refer to particular features, the scope of this invention also includes embodiments having different combinations of features and embodiments that do not include all of the described features. Accordingly, the scope of the present invention is intended to embrace all such alternatives, modifications, and variations together with all equivalents thereof.

What is claimed is:

1. A method of providing an extensible content delivery platform, the method comprising:
identifying a plurality of discrete events of a content delivery process of a content delivery network;
providing a structured object model comprising a plurality of objects instantiated and available at the plurality of discrete events; and
providing a programmatic grammar configured to provide a logical flow of actions being applied against the plurality of objects on occurrence of at least one of the plurality of discrete events of the content delivery process of the content delivery network.

2. A methods as recited in claim 1 wherein the operation of identifying the plurality of discrete events comprises using a structured event model to identify the plurality of discrete events.

3. A methods as recited in claim 1 wherein the operation of identifying the plurality of discrete events comprises using at least one rule to identify the plurality of discrete events.

4. A methods as recited in claim 1 further comprising a set of base functions to be performed at the plurality of discrete events.

5. A methods as recited in claim 1 further comprising a set of base functions to be performed upon the plurality of objects.

6. A cache server comprising:
a core engine executing on a processor of a cache server, the core engine comprising a structured event model identifying a plurality of discrete events of a content delivery process of a content delivery network, a structured object model comprising a plurality of objects instantiated and available at the plurality of discrete events, and a programmatic grammar configured to provide a logical flow of actions being applied against the plurality of objects on occurrence of at least one of the plurality of discrete events of the content delivery process of the content delivery network.

7. A cache server as recited in claim 6 wherein the logical flow of actions comprises user definable modules.

8. A cache server comprising:
a core engine executing on a processor of a cache server, the core engine comprising a set of rules configured to identify a plurality of discrete events of a content delivery process of a content delivery network, a structured object model comprising a plurality of objects instantiated and available at the plurality of discrete events, and a programmatic grammar configured to provide a logical flow of actions being applied against the plurality of objects on occurrence of at least one of the plurality of discrete events of the content delivery process of the content delivery network.

9. A cache server as recited in claim 8 wherein the logical flow of actions comprises user definable modules.
